(19) United States
(12) Patent Application Publication
(10) Pub. No.: US 2024/0324692 A1
(43) Pub. Date: Oct. 3, 2024

(54) AEROSOL PROVISION DEVICE WITH A MOISTURE SENSOR

(71) Applicant: NICOVENTURES TRADING LIMITED, London (GB)

(72) Inventor: Catalin MIHAI BALAN, London (GB)

(21) Appl. No.: 18/698,189

(22) PCT Filed: Nov. 7, 2022
(86) PCT No.: PCT/GB2022/052808

§ 371 Date: Apr. 3, 2024

(30) Foreign Application Priority Data
Nov. 10, 2021 (GB) 2116150.0

(51) Int. Cl. A24F 40/51; A24F 40/20; A24F 40/53

(52) U.S. Cl. CPC A24F 40/51; A24F 40/20; A24F 40/53

(57) ABSTRACT

An aerosol provision device for generating an aerosol from aerosol generating material received by the aerosol provision device. The aerosol provision device includes at least a controller for controlling an amount of power supplied to an aerosol generator to generate aerosol from the aerosol-generating material, and a sensor configured to estimate a level of moisture of the aerosol-generating material. The controller is configured to select an amount of power to supply to the aerosol generator based on the estimated level of moisture.

### FIELD

The present disclosure relates to aerosol provision systems such as nicotine delivery systems.

### BACKGROUND

Aerosol delivery systems generally contain a aerosol-generating material, such as a portion of a solid, liquid or gel, or a reservoir of a source liquid which may contain an active substance and/or a flavour, from which an aerosol or vapour is generated for inhalation by a user, for example through heat vaporisation. Thus, an aerosol provision system/electrical smoking system will typically comprise a heating chamber or aerosol generation chamber containing an aerosol generator, e.g. a heating element, arranged to vaporise or aerosolise a portion of aerosolisable material (e.g. a solid material such as tobacco) to generate a vapour or aerosol in the aerosol generation chamber. As a user inhales on the device, and electrical power is supplied to the heating element, air is drawn into the device through an inlet hole and along an inlet air channel connecting to the aerosol generation chamber where the air mixes with vaporised precursor material to form a condensation aerosol. An outlet air channel connects from the aerosol generation chamber to an outlet in the mouthpiece, and the air drawn into the aerosol generation chamber as a user inhales on the mouthpiece continues along the outlet flow path to the mouthpiece outlet, carrying the aerosol with it, for inhalation by the user. Some aerosol delivery systems may also include a flavour element in the air flow path through the device to impart additional flavours. Such devices may sometimes be referred to as hybrid devices, and the flavour element may, for example, include a portion of solid aerosol-generating and/or flavourant material such as tobacco arranged in the air flow path between the aerosol generation chamber and the mouthpiece such that aerosol/condensation aerosol drawn through the device passes through the portion of solid material before exiting the mouthpiece for user inhalation. In some aerosol delivery systems, the aerosol-generating material is contained in a cartridge or pod which also contains the heating element and aerosol generating chamber, and the cartridge is mechanically and electrically coupled to a control unit for use. The control unit comprises a battery and control circuitry which together supply power to the heating element via the cartridge.

Control schemes for the above aerosol delivery systems typically apply a predetermined amount of power in order to generate an aerosol. The predetermined amount of power is determined based on an ideal aerosol-generating material, and is not responsive to the degree of variability in the condition of aerosol-generating materials (e.g. variation in dryness). This may cause sub-optimal heating of an aerosol-generating material (e.g. if the aerosol-generating material is drier than expected it may burn leading to a charred taste). Similarly, a user may select an incorrect control scheme or forget to change a control scheme thereby leading to an aerosol generator using the wrong control scheme for an aerosol-generating material.

Various approaches are described herein which seek to help address or mitigate at least some of the issues discussed above.

### SUMMARY

The disclosure is defined in the appended claims.

According to a first aspect of the present disclosure, there is provided an aerosol provision device for generating an aerosol from aerosol generating material received by the aerosol provision device, the aerosol provision device comprising: a controller for controlling an amount of power supplied to an aerosol generator to generate aerosol from the aerosol-generating material; and a sensor configured to estimate a level of moisture of the aerosol-generating material; wherein the controller is configured to select an amount of power to supply to the aerosol generator based on the estimated level of moisture.

According to a second aspect of the present disclosure, there is provided an aerosol provision system comprising an aerosol provision device in accordance with the first aspect and a consumable for use with the aerosol provision device, wherein the consumable comprises the aerosol-generating material.

According to a third aspect of the present disclosure, there is provided a method of controlling an amount of power supplied to an aerosol generator of an aerosol provision system for generating an aerosol from aerosol generating material, the method comprising: estimating a level of moisture of the aerosol-generating material; selecting an amount of power based on the estimated level of moisture; and supplying the selected amount of power to the aerosol generator.

According to a fourth aspect of the present disclosure, there is provided a computer readable storage medium comprising instructions which, when executed by a processor, perform a method in accordance with the third aspect.

According to a fifth aspect of the present disclosure, there is provided aerosol provision means for generating an aerosol from aerosol generating material received by the aerosol provision means, the aerosol provision means comprising: control means for controlling an amount of power supplied to an aerosol generator means to generate aerosol from the aerosol-generating material; and sensing means configured to estimate a level of moisture of the aerosol-generating material; wherein the control means is configured to select an amount of power to supply to the aerosol generator means based on the estimated level of moisture.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

Embodiments of the disclosure will now be described, by way of example only, with reference to the accompanying drawings, in which:

FIG. 1 is a schematic cross-sectional view through an example aerosol provision system 1 in accordance with certain embodiments of the disclosure.

FIG. 2 is a schematic cross-sectional view through an example aerosol provision system 1 in accordance with certain embodiments of the disclosure.

FIGS. 3 and 4 relate to a unrolled view and a rolled view, respectively, of a wrapper for use in a consumable part of an example aerosol provision system 1 in accordance with certain embodiments of the disclosure.

FIG. 5 schematically represents a method of controlling an aspect of the electronic aerosol provision device in accordance with certain embodiments of the disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

As will be explained below, the present disclosure relates to an aerosol provision device comprising a controller and a moisture sensor is configured to control an amount of power supplied to an aerosol generator to generate aerosol from an aerosol-generating material by selecting an amount of power based on an estimated level of moisture measured by the moisture sensor (e.g. a level of moisture of the aerosol-generating material). The amount (and level) power supplied may ensure that sufficient quantities of aerosol are generated for inhalation (e.g. throughout a usage session), whilst preventing detrimental effects such as burning of aerosol-generating material or exhaustion of the aerosol-generating material mid session. In some examples, the controller selects the amount of power to supply by choosing an aerosol generation profile based on the estimated level of moisture. Selecting the amount of power (e.g. by selecting a aerosol generation profile) based on estimate moisture level allows for an appropriate (e.g. optimal) power to be supplied in a variety of circumstances. In some examples, the selection based on estimated moisture level allows for identification of different types of aerosol-generating materials, each of which may have a different aerosol generation profile. In some examples, the selection based on estimated moisture level allows the device to compensate for deterioration of an aerosol-generating material during storage, prior to use. In some examples, the selection based on estimated moisture level allows for identification of a usage state of the aerosol-generating material (e.g. where the material is designed to be used multiple times, and/or where a previous use has been interrupted), and to select an appropriate amount of power based on the remaining moisture in the aerosol-generating material as indicated by the estimated moisture level.

The present disclosure relates to aerosol provision systems (which may also be referred to as vapour delivery systems or aerosol delivery systems). As used herein, the term “delivery system” is intended to encompass systems that deliver at least one substance to a user, and includes non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolised. As appropriate, either material may comprise one or more active constituents, one or more flavours, one or more aerosol-former materials, and/or one or more other functional materials.

Aerosol-generating material is a material that is capable of generating aerosol, for example when heated, irradiated or energized in any other way. Aerosol-generating material may, for example, be in the form of a solid or gel which may or may not contain an active substance and/or flavourants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavours, one or more aerosol-former materials, and optionally one or more other functional material.

The active substance as used herein may be a legally permissible physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof.

The aerosol-former material may comprise one or more constituents capable of forming an aerosol. In some embodiments, the aerosol-former material may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

An aerosol-modifying agent is a substance, typically located downstream of the aerosol generation area, that is configured to modify the aerosol generated, for example by changing the taste, flavour, acidity or another characteristic of the aerosol. The aerosol-modifying agent may be provided in an aerosol-modifying agent release component, that is operable to selectively release the aerosol-modifying agent

The aerosol-modifying agent may, for example, be an additive or a sorbent. The aerosol-modifying agent may, for example, comprise one or more of a flavourant, a colourant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

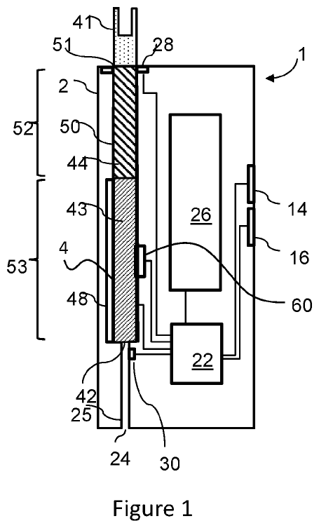

FIG. 1 is a cross-sectional view through an example aerosol provision system/heat-not-burn device 1 in accordance with certain embodiments of the disclosure. The aerosol provision system 1 comprises two main components, namely a reusable device part 2 and a replaceable consumable/cartridge/cartomiser part 4.

In normal use the reusable part 2 (i.e. aerosol provision device) and the consumable part 4 (i.e. consumable) are releasably coupled/attached together by partially or fully inserting the consumable part 4 into a chamber 50 of the reusable device part 2, comprising a heater chamber region/heating region 53. FIG. 1 schematically shows the reusable device part 2 with a consumable part 4 partially received into a chamber 50. Chamber 50 comprises a cylindrical tube extending into the reusable device part 2 from an outer housing surface of the reusable device part. In this example, the chamber extends into the device from an outer surface of the mouthpiece end of the reusable device part 2, defined as the uppermost part of the reusable device part as a user holds it in their hand for use, the chamber 50 extending parallel to the long axis of the reusable device part 2. An aperture 51 communicates between the chamber 50 and the exterior of the device.

In broad outline, the reusable device part 2 is configured to generate an aerosol to be inhaled by a user, typically by heating one or more aerosol-generating materials in the consumable part 4, either directly via one or more heating elements associated with the heating region 53 of the chamber 50, or by transmitting electrical energy or a magnetic field into the consumable part 4 to activate an aerosol generator such as a heating element in or on the consumable part 4. In use, a user inserts a consumable part 4 into the chamber 50 of the reusable device part via the aperture 51, and then activates the reusable device part 2, e.g. using a button 14, to cause the reusable device part 2 to supply power from a power supply/battery 26 to an aerosol generating element to aerosolise the aerosol-generating material(s) comprised in the consumable part 4 for inhalation by a user. The user subsequently draws on a mouthpiece 41 of the consumable part 4 which extends out of the aperture 51 at the mouthpiece end of reusable device part 2 to inhale an aerosol generated by the reusable device part 2. As a user draws on the mouthpiece 41 of consumable part 4, air is drawn into an air inlet 24 disposed on an outer surface of reusable part 2, down an air inlet channel 25, and into a heating region 53 of the chamber 50, wherein it enters at least one air inlet 42 of the consumable part 4, entraining vapour/aerosol generated via aerosolisation/heating of a portion of aerosol-generating material 43 comprised in the consumable part 4. For the same of a concrete example, FIG. 1 shows schematically a heating element 48 arranged around the heating region 53 of the chamber 50 as described further herein, which transmits heat into a portion of the consumable part 4 containing aerosol-generating material 43. The entrained vapour/aerosol travels through the consumable part 4 towards a mouthpiece end of the reusable device part 2 (from which a mouthpiece 41 of consumable part 4 extends), wherein aerosol droplets condense out or further condense out of the vapour/aerosol, forming a condensation aerosol which exits the mouthpiece 41 of the consumable part 4 for inhalation by the user.

The reusable part 2 comprises an outer housing having with an opening that defines an air inlet 24, a power source 26 (for example a battery) for providing operating power for the aerosol provision system, control circuitry 22 for controlling and monitoring the operation of the aerosol provision system, an optional user input button 14, an optional display 16, and a visual display/visual feedback indicator 28. The outer housing of the reusable device part 2 may be formed, for example, from a plastics or metallic material, or any other material known to the skilled person. For the sake of providing a concrete example, the reusable device part 2 may in some embodiments have a length of around 80 mm, and the consumable part 4 extends from the mouthpiece end of the reusable device part by approximately 10 to 30 mm when fully inserted into the chamber 50, so the overall length of the aerosol provision system 1 when the consumable part and reusable device part are coupled together is around 90 to 110 mm. The consumable part 4 may have a diameter of approximately 8 mm. However, and as already noted, it will be appreciated that the overall shape and scale of an aerosol provision system implementing an embodiment of the disclosure is not significant to the principles described herein.

The power source 26 in this example is rechargeable and may be of a conventional type, for example of the kind normally used in aerosol provision systems such as heat-not-burn devices, tobacco heating devices, electronic cigarettes and other applications requiring provision of relatively high currents over relatively short periods (for example, a lithium ion battery). The power source 26 may be recharged through a charging connector in the reusable part housing, comprising for example a micro-USB or USB-C connector, which may also provide an interface for data transfer between a controller 22 and an external processing device such as a smartphone or a personal computer.

A user input button 14 may optionally be provided, which in this example is a conventional mechanical button, for example comprising a spring mounted component which may be pressed by a user to establish an electrical contact. In this regard, the input button 14 may be considered an input devices for detecting user input and the specific manner in which the button is implemented is not significant (e.g. it may comprise a capacitive touch sensor and/or a touch-sensitive display element). A plurality of such buttons may be provided, with one or more buttons being assigned to functions such as switching the aerosol provision system 1 on and off, and adjusting user settings such as a power to be supplied from the power source 26 to an aerosol generator 48, and/or selecting one or more device modes. However, the inclusion of user input buttons is optional, and in some embodiments such buttons may not be included.

An optional display unit 16 may in some instances be provided on an outer surface of the housing of reusable device part 2. The display unit 16, where included, may comprises a pixilated or non-pixilated display unit (for example, comprising a single LED, an array of LEDs, a liquid crystal display (LCD), light-emitting diode (LED) display, organic light emitting-diode (OLED) display, active-matrix organic light-emitting diode (AMOLED) display, electroluminescent display (ELD), plasma display panel (PDP), e-ink display), connected to controller 22. The skilled person may implement such a display in accordance with any approaches known in the art. Such a display may be used for displaying to a user usage information about the use of the aerosol provision system 1. Exemplary forms of usage information which may be displayed to a user via an optional display unit 16 are described further herein.

At least one visual feedback indicator 28 is provided, with a display region visible on an outer surface of the housing of the reusable device part 2, the visual feedback indicator 28 being configured to provide visual feedback to a user about one or more aspects of the operation or status of the device. Such visual feedback may comprise information about, for example, whether the system is on or off, a selected operating mode, how much charge or aerosol-generating material remains in the aerosol provision system, the temperature of a heating element, or a strength with which a user is inhaling on the device (e.g. derived from an airflow sensor as described further herein). Such information may be shown before, during and/or after a puff or session on the aerosol provision device. The visual feedback indicator used to display such information may comprise a display panel comprising a plurality of pixels, comprising for example an LCD, LED, OLED, AMOLED, ELD, PDP, e-ink display, or any other form of pixilated display panel known to the skilled person. Additionally or alternatively, the visual feedback indicator 28 may comprise one or more non-pixilated display elements, such as one or more LEDs. As set out further herein, the at least one visual feedback indicator 28 may further comprise one or more light guiding elements, such as one or more light pipe, fibre optic or otherwise transparent or translucent light-transmitting elements, configured to guide a visual feedback signal from one or more light-emitting visual feedback elements situated within the housing of the reusable device part 2 to one or more display regions visible on, in or through a housing surface of the reusable device part 2.

A controller 22 is suitably configured/programmed to control the operation of the aerosol provision system to provide functionality in accordance with embodiments of the disclosure as described further herein, as well as for providing conventional operating functions of the aerosol provision system in line with the established techniques for controlling such devices. The controller (processor circuitry) 22 may be considered to logically comprise various sub-units/circuitry elements associated with different aspects of the operation of the aerosol provision system 1. In this example the controller 22 comprises power supply control circuitry for controlling the supply of power from the power source 26 to the aerosol generator 48 in response to user input, user programming circuitry for establishing configuration settings (e.g. user-defined power settings) in response to user input, as well as other functional units/circuitry associated functionality in accordance with the principles described herein and conventional operating aspects of aerosol provision systems, such as display driving circuitry and user input detection circuitry. It will be appreciated the functionality of the controller 22 can be provided in various different ways, for example using one or more suitably programmed programmable computer(s) and/or one or more suitably configured application-specific integrated circuit(s)/circuitry/chip(s)/chipset(s) configured to provide the desired functionality. The controller 22 may comprise a wireless transceiver and associated control circuitry enabling transfer of data between the reusable device part 2 and an external computing device such as a smartphone or personal computer (not shown), via a wireless transfer protocol such as Bluetooth, near-field communication (NFC) or Zigbee. The controller 22 also comprises one or more data storage elements (e.g. a memory element such as a ROM or RAM element) which can be used to store data associated with usage of the aerosol provision system, according to established techniques for data storage and transfer.

In some embodiments of the present disclosure, reusable device part 2 may comprise an airflow sensor 30 such as a pressure sensor or flow-rate sensor (for example a hot-wire anemometer) which is electrically connected to the controller 22, and in fluid communication with a portion of the airflow path between air inlet 24 and mouthpiece 41. The airflow sensor 30 may, for example, be disposed in a wall of the air inlet channel 25 or the chamber 50, and/or extend at least partially into or across a portion of an air flow pathway defined by air inlet channel 25 or the chamber 50). In some embodiments, a combined airflow and temperature sensor is used which allows the temperature of airflow in a portion of the airflow path in the device to be determined. In some embodiments, the airflow sensor comprises a so-called “puff sensor”, in that a signal from the airflow sensor 30 is used by the controller 22 to detect when a user is puffing on the device. In some embodiments, detection of a user puff (for example, by the controller 22 detecting a signal from the airflow sensor 30 indicative of pressure and/or flow rate in the airflow path between air inlet 24 and the mouthpiece 41, and determining it is above or below a predefined threshold) is used by the controller 22 to control the supply of power to the aerosol generator/heater 48. Accordingly, the controller 22 may distribute electrical power from the power source 26 to the aerosol generator 48 in dependence on at least a signal received from the airflow sensor 30 by the controller 22. The specific manner in which the signal output from the airflow sensor 30 (which may comprise a measure of capacitance, resistance or other characteristic of the airflow sensor, made by the controller 22) is used by the controller 22 to control the supply of power from the power source 26 to the aerosol generator 48. In some instances, signals received from the pressure sensor (i.e. the aerosol generator 48 is ‘puff activated’) is used by the controller 22 to switch on and/or off the supply of power to the aerosol generator 48 (e.g. by supplying power when an airflow parameter value determined on the basis of a signal received from the airflow sensor 30 is one side of a predefined threshold, and not supplying power when the airflow parameter value is the other side of the predefined threshold).

In other embodiments, the supply of power to the aerosol generator 48 is controlled via other means (e.g. by button 14), with the delivery of power being modified based on the signal received by the controller 22 from the airflow sensor (e.g. modulated in proportion to an airflow parameter determined based on a signal received from the airflow sensor 30). However, it will be appreciated that the inclusion of an airflow sensor is optional, and in some embodiments no airflow sensor is included. In such embodiments, the supply of power to the aerosol generator 48 may be switched on and off by a button 14, or may be switched on by a button 14, with the supply of power to the aerosol generator 48 being switched off by the controller 22 after a predetermined or predefined period of time has elapsed. For example, when the controller 22 detects a predetermined or predefined input signal (for example, supplied via a button 14, or comprising detecting via a suitable sensor that a user has inserted a consumable part 4 into the chamber 50).

The rate at which aerosol-generating material in the consumable part is vaporised by the aerosol generator/heater 48 will depend on the amount of power supplied to the aerosol generator 48 as well as the characteristics of the aerosol-generating material 43. Thus electrical power can be applied to the aerosol generator 48 to selectively generate aerosol from the aerosol-generating material in the consumable 4, and furthermore, the rate of aerosol generation can be changed by changing the amount of power supplied to the aerosol generator 48, for example through pulse width and/or frequency modulation techniques, under the control of controller 22.

The controller 22 may supply power in accordance with one of a number of predefined aerosol generation profiles. The controller 22 may specify (and implement) one or more aerosol generation profiles for use with a heater; such a profile determines the variation with time in the level of power that is supplied to the aerosol generator (or multiple aerosol generators). For example, for an aerosol generator which is a heater, the controller 22 may supply most power to the heater from the power source 26 at the start of a puff in order to rapidly warm the heater to its operating temperature, after which the controller 22 may supply a reduced level of power to the heater sufficient to maintain this operating temperature. A aerosol generation profile for a heater may be called a heating profile. A particular aerosol generation profile may be associated with a particular consumable 4, and may provide improved aerosol generation from the particular aerosol-generating material of the consumable based on the characteristics of the consumable. It will be appreciated that the terms “activation profile” or “operation profile” may be used instead of “aerosol generation profile”, in that the profiles determine how the aerosol generation is activated or operated during use.

The reusable part 2 typically comprises an aerosol generator 48 located in the vicinity of the heating region 53 of the consumable chamber 50. An aerosol generator is an element or apparatus configured to cause aerosol to be generated from the aerosol-generating material in the consumable part 4, for example, by heating. Accordingly, in some embodiments, the aerosol generator 48 comprises a heater configured to subject the aerosol-generating material in the consumable part 4 to heat energy, so as to release one or more volatiles from the aerosol-generating material to form an aerosol. In some embodiments, the aerosol generator is configured to cause an aerosol to be generated from the aerosol-generating material without heating. For example, the aerosol generator 48 may be configured to subject the aerosol-generating material in the consumable part 4 to one or more of vibration, increased pressure, or electrostatic energy to volatilise the aerosol-generating material. In some examples, an aerosol generator 48 comprising at least one heating element can be formed as a cylindrical tube, having a hollow interior heating chamber in which the aerosol-generating material 43 is provided; with the system being configured to heater the cylindrical tube either by induction or resistive heating. In some of these examples, the aerosol generator 48 is in the form of a hollow cylindrical tube which comprises, is embedded in, or surrounds the heating region 53 of chamber 50.

In some examples, the temperature of part of the aerosol generator 48, and/or a heating region 53 of the chamber 50, or the consumable part 4, or any part of the reusable device part 2, may be detected by the controller 22 using one or more temperature sensors. For example, a heating element comprised in aerosol generator 48 may comprise a material with a temperature coefficient of resistance property such that its resistance varies with temperature. The controller 22 may determine the resistance of the heating element via known approaches and compare this result with a look-up table derived via experimentation or modelling linking heating element resistance to temperature, in order to estimate a temperature of the aerosol generator 48 based on the measured resistance. Alternatively or in addition, one or more temperature sensing elements such as thermistors may be positioned in the vicinity of the heating region 53 (for example, attached to or embedded in a tube comprising the heating region 53 of the chamber 50), said thermistors being connected to the controller 22 to enable the controller to monitor the temperature of the consumable part 4 and/or the heating region 53. The temperature of air in the air inlet channel 25 may also be monitored by one or more temperature sensors (for example a combined temperature and pressure sensor or thermistor) in a similar manner.

It will be appreciated that in a two-part device such as shown in FIG. 1, portions of the aerosol generator 48 may be in either of the reusable device part 2 and/or the consumable part 4. It will further be appreciated that in some instances the consumable part 4 may comprise a cartridge containing an electrically operated aerosol generator (e.g. a heater), and that in addition to or in place of aerosol generator 48 in the reusable device part 2, the reusable device part 2 may comprise an electrical interface comprising electrical contacts disposed in chamber 50 which electrically connect the aerosol generator in the consumable part 4 with the power source 26 and controller 22 in the reusable device part 4 when the consumable part 4 is fully received within the chamber 50.

In some embodiments, the consumable part 4 is in the form of a cylindrical rod which has or contains aerosol-generating material 43 at an end distal to the mouthpiece 41, in a section of the consumable part 4 that is within the heating region 53 of the chamber 50 when the consumable part 4 is fully inserted in the reusable device part 2. For the sake of providing a concrete example, in one embodiment the consumable part 4 has a diameter of around 8 mm and a length of around 84 mm. The depth of the chamber 50 of the reusable device portion is sized relative to the length of the consumable part 4 such that a mouthpiece end 41 of the consumable part 4 typically extends from the aperture (for example, by 10 mm, 20 mm, 30 mm or more than 30 mm) when the consumable part 4 is fully inserted into the chamber 50.

Accordingly, a mouthpiece end of the consumable part 4 typically extends from the reusable device part 2, out of aperture 51. The consumable part 4 may include a filter/cooling element 44 for filtering/cooling aerosol, disposed between the mouthpiece 41 and a region of aerosol-generating material 43. The consumable part 4 is typically circumferentially wrapped in a wrapper/outer layer (not shown) which may comprise a paper material, and/or a metallic foil, and/or a polymer film such as Natureflex™. The outer layer of the consumable part 4 may be permeable to allow some heated volatilised components from the aerosol-generating material 43 to escape the consumable part 4 prior to reaching the mouthpiece 41. In some embodiments, the wrapper may comprise a metallic material in the vicinity of the aerosol-generating material 43, which is configured to act as a susceptor, which is heated by induction via one or more magnetic field generators/drive coils (not shown) in the reusable device part 2, so as to heat the aerosol-generating material 43 via inductive heating. For example, in such embodiments, the aerosol generator 48 may comprise one or more magnetic field generators/drive coils configured to induce inductive heating of a metallic wrapper of consumable 4, and/or one or more susceptor elements embedded within the aerosol-generating material 43 within the consumable part 4, to induce heating of aerosol-generating material 43 in the consumable part 4. It will be appreciated the configuration of the consumable part 4 set out above is illustrative, and the skilled person may modify the overall structure of the consumable part according to approaches known in the art.

Typically, the primary flow path for heated volatilised components produced by heating of the aerosol-generating material 43 by the heater 48 is axially through the consumable part 4, through the filter/cooling element 44 (where included), and into a user's mouth through the open end of the mouthpiece 41. However, some of the volatilised components may escape from the consumable part 4 through its permeable outerwrapper and into a space surrounding the consumable part 4 in the non-heated chamber region 52 (e.g. a space formed by an optional gap (not shown) between the outer surface of the consumable 4 and the inner surface of the chamber 50 in the flared portion of the non-heating/expansion chamber region 53).

Once all, or substantially all, of the volatilisable component(s) of the aerosol-generating material in the consumable part 4 have/have been exhausted, the user may remove the consumable part 4 from the reusable device part 1 and dispose of the consumable part 4. The user may subsequently re-use the reusable device part 2 with another consumable part 4. However, in other respective embodiments, the consumable part 4 and the reusable device part 2 may be disposed of together once the volatilisable component(s) of the aerosol-generating material has/have been spent. The consumable part 4 may be configured with a quantity of aerosol-generating material 43 which is configured to be heated and exhausted over a single heating cycle (for example, an activation duration of 210 seconds), or may be configured with quantity of aerosol-generating material 43 which is configured to be exhausted over a plurality of heating cycles (or implementations of a heating profile).

In some embodiments, the consumable part 4 may be sold, supplied or otherwise provided separately from the reusable device part 2 with which the consumable part 4 is usable. However, in some embodiments, the reusable device part 2 and one or more of the consumable parts 4 may be provided together as a system such as a kit or an assembly, possibly with additional components, such as cleaning utensils.

As described further herein, the reusable device part 2 includes a sensor 60 configured to estimate a level of moisture of the aerosol-generating material 43. The sensor may estimate a level of moisture of a part, section or portion of aerosol-generating material. example the sensor 60 may be configured to estimate a level of moisture in or adjacent to the aerosol-generating material, such as a level of moisture between two contacts on (or near to) either side of the aerosol-generating material such that a measurement is made of the moisture within the material, and of any moisture on the surface of the material, between the contacts. Such a sensor 60, may be termed a moisture sensor, and may estimate a level of moisture based on any suitable parameter (or combination of parameters). By a level of moisture it is meant that the liquid content or moisture content of the aerosol-generating material is estimated.

In some examples, the aerosol-generating material comprises a solid aerosol-generating material or a gel aerosol-generating material. For example, the aerosol-generating material may be a solid or gel-like substance, such as a tobacco based material or a different plant based material, which comprises a liquid, such as water, glycerol, propylene glycol, or a combination. For example, the aerosol-generating material may have absorbed an amount of liquid during growth, manufacture and/or conditioning of the material. The moisture sensor is configured to measure (e.g. sense) the liquid content (e.g. fluid or water content), and/or to provide a measurement which is indicative of a liquid content without directly measuring the amount of liquid.

By estimate, it is meant that the sensor 60 measures a parameter (or multiple parameters) which is indicative of the aerosol-generating material having a particular level of moisture (e.g. a look up table of moisture levels for particular values of the parameter may be provided to the sensor 60 during manufacture, with the values of the lookup table being based on empirical measurements). For example a first value of the parameter may correspond to a high or maximum liquid level, a second value of the parameter may correspond to a low or minimum liquid level, and a plurality of intermediate values of the parameter may correspond to a plurality of liquid levels between the high and low (minimum and maximum) liquid levels of the first and second value. In some examples the measured parameter(s) can be processed to calculate, or otherwise determine, the likely level of moisture corresponding to the measured parameter(s) (e.g. based on a predefined formula). For example, the value of the parameter(s) can be used as an input into a formula to produce the estimated moisture level as an output. The sensor 60 is configured to provide (e.g. send or transmit) the estimate to the controller 22. In some examples, the sensor 60 may store the estimate in a memory of the controller 22 or a memory accessible by the controller 22.

In some examples, the moisture sensor 60 may measure an electrical characteristic associated with at least a portion of the aerosol-generating material 43. A suitable electrical characteristic may be a resistance, conductance, impedance or capacitance across at least a portion of the aerosol-generating material 43. In some of these examples, the electrical characteristic may additionally measure across a portion of a different component of the consumable 4, such as a housing or wrapper of the consumable 4. In some embodiments suitable techniques known in the art may be implemented in order to compensate for the presence of these other components (e.g. to remove background effects). A suitable moisture sensor 60 may be implemented in the present system in accordance with any approaches known in the art.

In some examples, the moisture sensor 60 may measure an optical characteristic of at least a portion of the aerosol-generating material 43. In some examples the moisture sensor 60 may measure a parameter related to a surface reflection of at least a portion of the aerosol-generating material 43. In some examples, the moisture sensor 60 may measure a parameter related to transmission through at least a portion of the aerosol-generating material 43.

In some examples, the moisture sensor 60 may be configured to take measurements of a single portion of an aerosol-generating material 43. In some examples, the moisture sensor 60 may comprise multiple parts, each of which is configured to take measurements of a respective portion of the aerosol-generating material 43. A moisture sensor 60 of these examples will send to the controller 22, either signals from each of the parts, or an estimated level of moisture based on measured signals from each of the parts. In some examples, additional moisture sensors may be provided to measure different respective portions of the aerosol generation material 43. Each moisture sensor is configured to communicate with the controller 22 directly. In some of the above examples, the respective portions are distinct and non-adjacent, whilst in other examples the respective portions may be adjacent or overlap to some extent.

As discussed above the controller is configured to control the amount of power supplied to an aerosol generator to generate aerosol from an aerosol-generating material. In some examples, the amount of power supplied to the aerosol generator 48 is dependent on an aerosol generation profile selected by the controller 22 based on the estimated level of moisture. The aerosol generation profile determines the variation with time in the level of power supplied to the aerosol generator. In some examples the aerosol generation profiled determines the level of power supplied to multiple generators, each of which may be supplied with a unique amount of power. In some examples, the aerosol generation profile indicates a first power level to be supplied during a initial time period, and at least one further power level to be supplied during a subsequent time period. In some examples, an aerosol generation profiles indicates the respective power levels to be supplied during a number of subsequent time periods after the initial time period, wherein the number of subsequent time periods is greater than one.

In some examples, the aerosol generation profile may be associated with or otherwise relate to a session cycle. By a session cycle (e.g. a heating cycle) it is meant a fixed amount of time corresponding to a session of use by the user. In some examples, the session cycle corresponds to a time period necessary to aerosolise substantially all of the aerosol-generating material in a consumable part 4. In some examples, the controller supplies an amount of power to the aerosol generator based on a selected aerosol generation profile by initiating a session cycle. The controller is configured to cause an amount of power to be supplied to the aerosol generator for the duration of the session cycle; the amount of power defined by the selected aerosol generation profile. For example, an aerosol generation profile may be divided into a pre-defined number of time periods, each of which has a corresponding power level to be supplied during the time period.

In some examples, the controller 22 is configured to supply an amount of power to the aerosol generator for an amount of time which is defined at least in part by a user. For example, the controller 22 may supply an amount of power to the aerosol generator for as long as a user is puffing (as determined by airflow sensor 30) or as long as a user is holding down button 14, or between a first press of button 14 to start the supply of power and a second press of button 14 to stop the supply of power. In some examples, an aerosol generation profile may indicate the power to be supplied in an initial period and one or more subsequent periods, where at least a final period of the one or more subsequent periods is either open ended such that power is continuously applied as long as the user is still deemed to be activating the device (e.g. they are still puffing), or implements a final cut off such that the controller stops the supply of power to the aerosol generator 48 regardless of whether the user has stopped the activation of the device (e.g. they have not stopped puffing) when the final period is reached.

In some examples, the controller 22 is configured to select an aerosol generation profile from a plurality of predefined aerosol generation profiles. For example, the controller 22 may receive an estimated moisture level from the sensor 60 and identify a particular one of the plurality of predefined aerosol generation profiles. By “predefined” it is meant that the plurality of aerosol generation profiles are available prior to the selection. In some examples, the controller 22 is provided with the relevant values or parameters during manufacture (e.g. as part of installation of software) or during a software update. Thus, the controller 22 may obtain the relevant values from a memory, or the like, which stores the relevant values. The controller 22 is configured to select the predefined aerosol generation profile that is appropriate for the estimated moisture level. For example the controller 22 may select the predefined aerosol generation profile which provides optimal heating for an aerosol-generating material 43 having the estimated moisture level.

In some examples, the controller 22 is configured to select an aerosol generation profile by calculating the aerosol generation profile based on the estimated moisture level. For example, the controller 22 may receive an estimated moisture level from the sensor 60 and may select the aerosol generation profile by calculating how the power should vary over time based on one or more predefined formula. In some examples, the controller 22 may calculate a number of power levels to be supplied during a number of respective time periods.

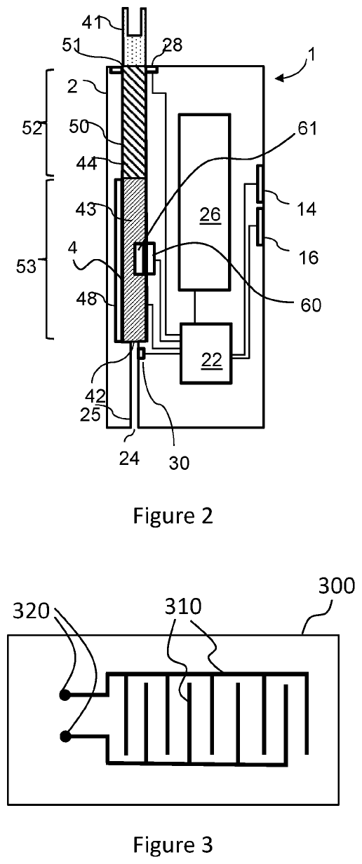

FIG. 2 is a cross-sectional view through an example aerosol provision system/heat-not-burn device 1 in accordance with certain embodiments of the disclosure. The aerosol provision system 1 comprises two main components, namely a reusable device part 2 and a replaceable consumable/cartridge/cartomiser part 4. The components of FIG. 2 are substantially as described in relation to FIG. 1. FIG. 2 differs from FIG. 1 in that the consumable part 4 comprises a conductive material 61.

The conductive material 61 facilitates the measurement of the level of moisture by the sensor 60. As such, the conductive material 61 may align with a part of the sensor 60 (e.g. one or more electrical contacts of the sensor) when the consumable part 4 is positioned correctly within the reusable device part 2. For example, the consumable part 4 may be inserted into the reusable part 2 with the conductive material 61 positioned adjacent a part of the sensor 60. The conductive material 61 may facilitate electrical measurement across a portion of the aerosol-generating material. By conductive it is meant that the material is a good conductor of electricity. In some examples, the conductive material may be in the form of a conductive plate, a conductive wire, or a conductive ink.

In some examples, the moisture sensor 60 may measure an electrical characteristic associated with at least a portion of the aerosol-generating material 43. A suitable electrical characteristic may be a resistance, conductance, impedance or capacitance across at least a portion of the aerosol-generating material 43. In some examples, the conductive part 61 is provided to allow measurement across the portion of aerosol-generating material 43, without additionally measuring across a portion of a different component of the consumable 4. In other words, the conductive part 61 may provide an electrical pathway through the other components of the consumable 4. As a result, electrical measurements by the moisture second 60, which are carried out via the conductive material 61, are less affected by background effects caused by the other components, if at all. As such, it is advantageous for the sensor 60 to be configured to estimate a level of moisture by measuring an electrical characteristic via a conductive material 61 as described above.

In some examples, the conductive material 61 is configured to not contact the aerosol-generating material 43 until the consumable part 4 is inserted into, or otherwise connected to, the reusable device part 2. For example, the conductive material 61 may be separated from the aerosol-generating material 43 by a housing of the consumable part 4 or by a barrier material. In these examples, the conductive material 61 is configured to move into contact with the aerosol-generating material 43 upon insertion or attachment of the consumable part 4 to the aerosol provision device 2. For example, upon insertion, the conductive material 61 is pushed through the housing or barrier material into contact with the aerosol-generating material 43. Configuring the consumable part 4 such that the conductive material 61 does not contact the aerosol-generating material 43 can prevent corrosion of the conductive material 61 and/or deterioration of the aerosol-generating material 43.

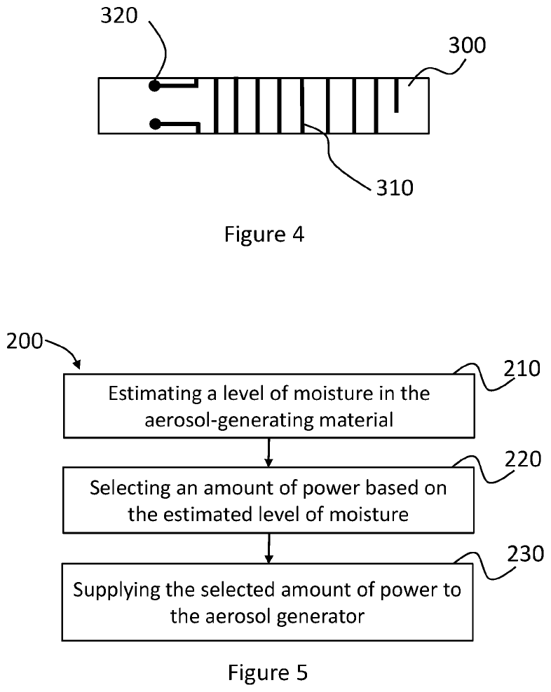

FIGS. 3 and 4 relate to a unrolled view and a rolled view, respectively, of a wrapper 300 for use in a consumable part 4 of an example aerosol provision system 1 in accordance with certain embodiments of the disclosure. For example, the wrapper 300 can be used to surround the aerosol-generating material 43 of the consumable part 4, as well as optionally other components of the consumable part 4. The wrapper 300 may be a paper wrapper (e.g. a cigarette paper), or may be any other suitable material (e.g. a polymer). The wrapper 300 includes a set of two electrodes 310 printed on the (outer) surface of the wrapper 300. Each electrode 310 is printed using conductive ink (e.g. graphene ink or silver ink). In other words, each electrode 310 comprises a layer of conductive ink printed onto the surface of the wrapper 300. As such the electrodes 310 provide an example of a conductive material 61 for use with a moisture sensor 60 as described above in relation to FIG. 1. Using the electrodes 310 printed on the wrapper 300 the moisture sensor 60 will be able to monitor the water moisture not only at the beginning of a session, but also over a session of use. The controller 22 can therefore adapt the power supplied to the heater accordingly, based on the measured moisture content

As shown in FIGS. 3 and 4, each electrode 310 may comprise a branched pattern. The branches of each electrode 310 may interleave, such that alternating circumferentially extending branches of each electrode 310 alternate along a longitudinal axis of the wrapper when rolled up (i.e. FIG. 4). This arrangement is advantageous in allowing measurements to be made irrespective of the orientation of the system 1 and for measurements to be made across substantially the entire longitudinal extension of the electrodes 310 (i.e. the range of the wrapper 300 in which the electrodes 310 have been printed) such that the moisture level measured is more representative of the moisture content of the whole of the aerosol generating material 43.

Each electrode 310 further includes an electrical connection 320 at a respective end of the electrode 310. Other ends of the electrode 310 do not necessarily include an electrical connection 320. Furthermore, while FIGS. 3 and 4 depict that the electrical connection 320 for each electrode 310 is at the same end of the electrode 310 (e.g. towards the same end of the rolled up cigarette paper of FIG. 4), in other examples the electrical connections 320 may be at opposite ends of their respective electrodes 310, or one or both may be at a midpoint of a respective electrode 310.

Electric connection of the electrical connections 320 of the wrapper to the device part 2 will be performed via two electrical pads (not shown) located in the device part 4 (e.g. provided by moisture sensor 60). The electrical pads may be designed and placed in such a way to create a connection with the consumable part 4 regardless of the orientation. The moisture sensor 60 is able to measure a signal indicating a moisture level which is dependent on the liquid level between the adjacent branches of each electrode 310.

While FIGS. 3 and 4 depict two electrodes having a branching arrangement, in other examples, different patterns of electrodes may be used, and/or more than two electrodes may be provided, each of which will have an electrical connection. For example, rather than having an interleaving pattern, a simple track or line segment using conductive ink could be provided on each side of a consumable.

FIG. 5 schematically represents a method 200 of controlling an aspect of the electronic aerosol provision system/device 1 for generating aerosol in accordance with certain embodiments of the disclosure. The method may be performed by suitable electronics as described above, and including a moisture sensor 60 and a controller 22.

The first step 210 of the method 200 is to estimate a level of moisture in the aerosol-generating material. The step 210 is carried out by the moisture sensor which estimates a level of moisture by sensing (e.g. measuring) one of more values of one or more parameters indicative of a moisture level of at least a portion of the aerosol-generating material. The estimated level provides an estimated moisture content (e.g. liquid content) of the aerosol-generating material. By an estimate it is meant that the moisture level of the whole of the aerosol-generating material is predicted based on the measurements (e.g. sensed values). The level of moisture can be estimated as detailed above in relation to FIGS. 1 and 2. In some examples, the moisture sensor is configured to provide (e.g. send or transmit) the estimate to the controller 22. In some examples, the sensor 60 may store the estimate in a memory of the controller 22 or a memory accessible by the controller 22.

In some examples, the estimated moisture level allows for identification of a particular type of aerosol-generating material, each of which may be provided in a different consumable part. For example a first aerosol-generating material may have a first moisture level and second aerosol-generating material may have a second moisture level. Further aerosol-generating materials may have their own respective moisture levels. While there may be some variability between moisture levels of consumable parts having a same type of aerosol-generating material, this variation is smaller than the difference between consumable parts having different types of aerosol-generating materials, thereby allowing the estimated moisture level to be used for identification.

In some examples, the estimated moisture level provides an indication of a level of deterioration (e.g. drying out) of the aerosol-generating material. For example, consumable parts may be stored for long period of time (e.g. several months to a year) whilst they are transported and stocked prior to purchase and use by a user. During this time period there is the potential for the moisture level of the aerosol-generating material to change (e.g. the aerosol-generating material dries out if not stored correctly). The estimated moisture level can be used to identify how the aerosol-generating material compares to a reference moisture level.

In some examples, the estimated moisture level allows for identification of a usage state of the aerosol-generating material. By usage state it is meant that the estimated moisture level allows for identification of how much the aerosol-generating material has been used. For example, as aerosol is generated from the aerosol-generating material, the moisture level of the aerosol-generating material changes. The moisture sensor can detect a level of estimated moisture which corresponds to the level of liquid remaining in the aerosol-generating material.

The second step 220 of the method 200 is to select an amount of power based on the estimated level of moisture. The step 220 is carried out by the controller which performs one or more processes as detailed above in relation to FIGS. 1 and 2 to select an appropriate amount of power for the estimated level of moisture. In some examples, an amount of power is selected by selecting an aerosol generation profile. In some examples, the aerosol generation profile is a heating profile, where the aerosol generator is a heater (i.e. is configured to generate aerosol by applying heat to the aerosol-generating material).

As detailed above, the estimated moisture level can be used to differentiate between different types of aerosol-generating material, because each aerosol-generating material may have a substantially different target moisture level. The controller can use the estimated moisture level to determine which aerosol-generating material is being used, and to select an amount of power to supply for that aerosol-generating material. In some examples, an aerosol generation profile is selected that is suitable or optimal for the aerosol-generating material. For example, each aerosol-generating material that is intended to be used in the system may have its own aerosol generation profile. Each such profile may be preinstalled or downloaded onto memory accessible by the controller.

As also detailed above, the selection of the aerosol generation profile allows the controller to compensate for deterioration of the aerosol generation material over time (e.g. while in storage, prior to use). The controller can use the estimated moisture level to determine whether the moisture level of aerosol-generating material differs from an expected or reference moisture level. If the estimated moisture level does not differ substantially (e.g. within a threshold range, or within the sensitivity of the moisture sensor) from the expected moisture level, then the controller can select a first amount of power. If the estimated moisture level does differ substantially (e.g. more than a threshold range, or by a detectable amount) then the controller can select a different amount of power. In some examples, to select an amount of power, the controller may select a different aerosol generation profile from a plurality of different aerosol generation profiles (e.g. dependent on if the difference falls within a first range, a second range etc.).

As also stated above, the selection of the aerosol generation profile allows for the controller to compensate for aerosol-generating materials which have already been used to some extent. For example, the controller can use the level of estimated moisture to infer a usage state of the aerosol-generating material and to select an appropriate aerosol generation profile based on the usage state. For example, if the level of estimated moisture is above a threshold value then the controlled may identify that the aerosol-generating material has not been used, or has been used very little, and can select a first amount of power (e.g. by selecting an first aerosol generation profile) which is typically used with new consumables and/or aerosol-generating materials. However, if the level of estimated moisture is below a threshold value then the controlled may identify that the aerosol-generating material has been used, and can select a different amount of power (e.g. by selecting a different aerosol generation profile) suitable for aerosol-generating materials which have been used previously. For example, the different amount of power may supply less power over time as there is less mass (i.e. less liquid) to heat in the aerosol-generating material. Alternatively, initially a greater amount of power may be supplied to ensure that an equivalent amount of aerosol is provided to the user at the beginning of the session. It will be appreciated that the controller may select from more than two aerosol generation profiles, each of which is appropriate for a respective range of estimated moisture levels.

The third step 230 of the method 200 is to supply the selected amount of power to the aerosol generator. The step 230 is performed by the controller which causes the selected amount of power to be supplied to the aerosol generator. In some examples, the level of power may vary over time as defined by a selected aerosol generation profile. The amount of power can be applied as detailed above in relation to FIGS. 1 and 2. As discussed above, the power supplied is appropriate for an aerosol-generating material having the estimated level of moisture. For example, the amount (and level) power supplied in accordance with the aerosol generation profile may ensure that sufficient quantities of aerosol are generated for inhalation (e.g. throughout a usage session), whilst preventing detrimental effects such as burning of aerosol-generating material or exhaustion of the aerosol-generating material mid session.

The method 200 illustrated in FIG. 5 may be stored as instructions on a computer readable storage medium, such that when the instructions are executed by a processor, the methods 200 described above are performed. The computer readable storage medium may be non-transitory.

Thus, there has been described an aerosol provision device for generating an aerosol from aerosol generating material received by the aerosol provision device, the aerosol provision device comprising: a controller for controlling an amount of power supplied to an aerosol generator to generate aerosol from the aerosol-generating material; and a sensor configured to estimate a level of moisture of the aerosol-generating material; wherein the controller is configured to select an amount of power to supply to the aerosol generator based on the estimated level of moisture.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device for generating an aerosol from aerosol generating material received by the aerosol provision device, the aerosol provision device comprising:
a controller for controlling an amount of power supplied to an aerosol generator to generate aerosol from the aerosol-generating material; and
a sensor configured to estimate a level of moisture of the aerosol-generating material;
wherein the controller is configured to select an amount of power to supply to the aerosol generator based on the estimated level of moisture.

2. The aerosol provision device of claim 1, wherein the controller is configured to control the amount of power supplied to the aerosol generator by applying power in accordance with an aerosol generation profile, wherein the controller is configured to select an aerosol generation profile based on the estimated level of moisture.

3. The aerosol provision device of claim 2, wherein the controller is configured to select the aerosol generation profile from a plurality of predetermined aerosol generation profiles.

4. The aerosol provision device of claim 2, wherein the controller is configured to select the aerosol generation profile by generating the aerosol generation profile using the estimated moisture level.

5. The aerosol provision device of claim 1, wherein the aerosol generator is a heater and the aerosol generation profile is a heating profile.

6. An aerosol provision system comprising the aerosol provision device of claim 1 and a consumable for use with the aerosol provision device, wherein the consumable comprises the aerosol-generating material.

7. The aerosol provision system of claim 6, wherein the aerosol-generating material comprises a solid aerosol-generating material or a gel aerosol-generating material.

8. The aerosol provision system of claim 6, wherein the consumable comprises a conductive material, wherein the sensor is configured to estimate a level of moisture by measuring an electrical characteristic via the conductive material.

9. The aerosol provision system of claim 8, wherein the conductive material is configured to move into contact with the aerosol-generating material upon insertion or attachment of the consumable to the aerosol provision device.

10. The aerosol provision system of claim 8, wherein the conductive material is a conductive ink.

11. A method of controlling an amount of power supplied to an aerosol generator of an aerosol provision system for generating an aerosol from aerosol generating material, the method comprising:
estimating a level of moisture of the aerosol-generating material;
selecting an amount of power based on the estimated level of moisture; and
supplying the selected amount of power to the aerosol generator.

12. A non-transitory computer readable storage medium comprising instructions which, when executed by a processor, perform the method of claim 11.

13. Aerosol provision means for generating an aerosol from aerosol generating material received by the aerosol provision means, the aerosol provision means comprising:
control means for controlling an amount of power supplied to an aerosol generator means to generate aerosol from the aerosol-generating material; and
sensing means configured to estimate a level of moisture of the aerosol-generating material;
wherein the control means is configured to select an amount of power to supply to the aerosol generator means based on the estimated level of moisture.
